(19) United States
(12) Patent Application Publication
(10) Pub. No.: US 2020/0279401 A1
(43) Pub. Date: Sep. 3, 2020

(54) INFORMATION PROCESSING SYSTEM AND TARGET INFORMATION ACQUISITION METHOD

(71) Applicant: SONY INTERACTIVE ENTERTAINMENT INC., Tokyo (JP)

(72) Inventor: Tatsuo TSUCHIE, TOKYO (JP)

(21) Appl. No.: 16/648,090

(22) PCT Filed: Sep. 27, 2017
(86) PCT No.: PCT/JP2017/035066

§ 371 Date: Mar. 17, 2020

(51) Int. Cl. G06T 7/00; G06T 7/73; H04N 13/282

(52) U.S. Cl. CPC G06T 7/97; H04N 13/282; G06T 7/73

(57) ABSTRACT

Multiple imaging apparatuses 12a and 12b are arranged to capture images of a space in which an HMD 18 is found. The images captured by the imaging apparatuses are analyzed individually to acquire position and posture information regarding the HMD 18 in each of camera coordinate systems of the apparatuses. The position and posture information is aggregated to one information processing apparatus and transformed thereby into information in a world coordinate system independent of the imaging apparatuses. Relative relations between the positions and postures of the imaging apparatuses are acquired by making use of a period during which the HMD 18 is in a region 186 where the fields of view of the imaging apparatuses overlap with each other. The relative relations are used as the basis for acquiring parameters for transforming coordinates between the imaging apparatuses.

### TECHNICAL FIELD

The present invention relates to an information processing apparatus and a target information acquisition method for acquiring status information regarding a target on the basis of captured images.

### BACKGROUND ART

Games may be played by a user watching a display screen of a head-mounted display (referred to as an HMD hereunder) worn on a head and connected with a game machine (e.g., see PTL 1). If a position and posture of the user's head are acquired so that images of a virtual world are displayed in such a manner that a field of view is varied in accordance with face orientation, for example, this can create a situation in which the user feels as if he or she is in the virtual world. The position and posture of the user are generally acquired from a result of analyzing visible and infrared light images captured of the user and from measurements taken by motion sensors incorporated in the HMD.

### CITATION LIST

### Patent Literature

[PTL 1]

Japanese Patent No. 5580855

### SUMMARY

### Technical Problems

Technology for performing any kind of information processing on the basis of captured images is based on an assumption that a target such as a user is within an angle of view of a camera. However, because the user wearing the HMD cannot view the outside world, the user may become disoriented or may be immersed in a game so much that the user may move to an unexpected location in real space without noticing it. This puts the user out of the angle of view of the camera, disrupting the ongoing information processing or lowering its accuracy. Furthermore, the user may remain unaware of a cause of such aberrations. Regardless of the HMD being used or not, in order to implement information processing in more diverse ways with a minimum of stress on the user, it is desirable to acquire status information stably in a more extensive movable range than before.

The present invention has been made in view of the above problems. An object of the invention is therefore to provide techniques that, in acquiring status information regarding the target by image capture, extend the movable range of the target in an easy and stable manner.

### Solution to Problems

One embodiment of the present invention is an information processing system. The information processing system includes: multiple imaging apparatuses configured to capture images of a target from different points of view at a predetermined rate; and an information processing apparatus configured to analyze each of the images covering the target captured by the multiple imaging apparatuses so as to individually acquire sets of position and posture information regarding the target, the information processing apparatus further using one of the sets of the position and posture information to generate and output final position and posture information at a predetermined rate.

Another embodiment of the present invention is a target information acquisition method. The information acquisition method includes the steps of: causing multiple imaging apparatuses to capture images of a target from different points of view at a predetermined rate; and causing an information processing apparatus to analyze each of the images covering the target captured by the multiple imaging apparatuses so as to individually acquire sets of position and posture information regarding the target, the information processing apparatus being further caused to use one of the sets of the position and posture information to generate and output final position and posture information at a predetermined rate.

Incidentally, if other combinations of the above-outlined constituent elements or the above expressions of the present invention are converted between different forms such as a method, an apparatus, a system, a computer program, and a recording medium that records the computer program, they still constitute effective embodiments of this invention.

### Advantageous Effect of Invention

In acquiring status information regarding a target by image capture, the techniques according to the present invention permit extension of the movable range of the target in an easy and stable manner.

### BRIEF DESCRIPTION OF DRAWINGS

FIG. 1 is a view depicting an exemplary configuration of an information processing system to which an embodiment of the present invention may be applied.

FIG. 2 is a view depicting an exemplary external shape of an HMD according to the embodiment.

FIG. 3 is a view depicting an internal circuit configuration of an information processing apparatus having main functions according to the embodiment.

FIG. 4 is a view depicting an internal circuit configuration of the HMD according to the embodiment.

FIG. 5 is a view depicting configurations of functional blocks in information processing apparatuses according to the embodiment.

FIG. 6 is a view depicting relations between the arrangement of imaging apparatuses on one hand and the movable range of the HMD on the other hand according to the embodiment.

FIG. 7 is a view explaining a technique by which a transformation parameter acquisition section according to the present embodiment obtains parameters for transforming local information to global information.

FIG. 8 is a flowchart depicting a processing procedure in which the information processing apparatuses according to the embodiment acquire position and posture information regarding a target so as to generate and output data reflecting the acquired information.

FIG. 9 is a view explaining a technique of reciprocal transformation of timestamps between the information processing apparatuses according to the embodiment.

FIG. 10 is a view depicting an exemplary arrangement of three or more pairs of the imaging apparatus and the information processing apparatus according to the embodiment.

### DESCRIPTION OF EMBODIMENTS

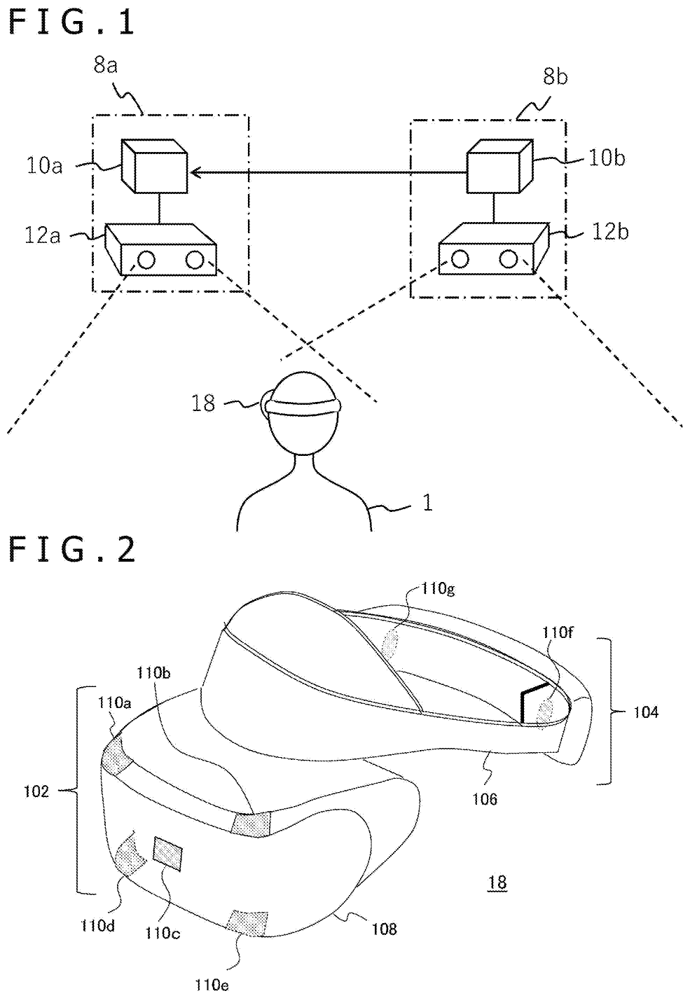

FIG. 1 depicts an exemplary configuration of an information processing system to which an embodiment of the present invention may be applied. The information processing system is configured with multiple pairs 8a and 8b of imaging apparatuses 12a and 12b for capturing images of a target and of information processing apparatuses 10a and 10b for acquiring position and posture information regarding the target using the images captured by the imaging apparatuses. The target is not limited to anything specific. By acquiring the position and posture of an HMD 18, for example, the system identifies the position and motion of a head of a user 1 wearing the HMD 18, and displays images in a field of view in accordance with the user's line of sight.

The imaging apparatuses 12a and 12b have cameras for capturing images of the target such as the user at a predetermined frame rate, and mechanisms for generating output data representing captured images obtained by performing common processes such as demosaicing on an output signal from the cameras, before outputting generated data to the paired information processing apparatuses 10a and 10b with which communication is established. The cameras include visual light sensors such as CCD (Charge Coupled Device) sensors or CMOS (Complementary Metal Oxide Semiconductor) sensors used in common digital cameras and digital video cameras. The imaging apparatus 12 may include either a single camera or what is called a stereo camera having two cameras disposed right and left at a known distance apart as illustrated.

Alternatively, the imaging apparatuses 12a and 12b may each be constituted by combining a monocular camera with an apparatus that emits reference light such as infrared light to the target and measures reflected light therefrom. In the case where the stereo camera or the reflected light measuring mechanism is installed, it is possible to obtain the position of the target in a three-dimensional space with high accuracy. It is well known that the stereo camera operates by the technique of determining the distance from the camera to the target by the principle of triangulation using stereoscopic images captured from right and left points of view. Also well known is the technique of determining the distance from the camera to the target through measurement of reflected light on a TOF (Time of Flight) basis or by use of a pattern projection method.

However, even where the imaging apparatuses 12a and 12b are a monocular camera each, by attaching markers of predetermined sizes and shapes to the target or by having the size and shape of the target made known beforehand, it is possible to identify the position of the target in the real world from the position and size of images captured of the target.

The information processing apparatuses 10a and 10b establish communication with the corresponding imaging apparatuses 12a and 12b, respectively, to acquire information regarding the position and posture of the target using data of its images captured and transmitted by the imaging apparatuses. Generally, the position and posture of the target obtained with the above-described techniques using captured images are given as information in a camera coordinate system that has its origin at the optical center of each imaging apparatus and has the axes oriented in the longitudinal, crosswise, and vertical directions of the imaging plane of the information apparatus. With this embodiment, the position and posture information regarding the target is first obtained by the information processing apparatuses 10a and 10b in each camera coordinate system.

The information in the camera coordinate systems is then transformed to information in a world coordinate system integrating these coordinate systems. This generates the final position and posture information regarding the target. This makes it possible to perform information processing using the position and posture information regardless of the field of view of any imaging apparatus covering the target. That is, the movable range of the target is extended by an amount reflecting the number of configured imaging apparatuses without affecting subsequent processes. Because the information processing apparatuses 10a and 10b acquire and use the position and posture information independently in the camera coordinate systems of the corresponding imaging apparatuses 12a and 12b, the existing pairs 8a and 8b of the imaging apparatuses and information processing apparatuses may be utilized unmodified, which makes system implementation easy to accomplish.

FIG. 1 depicts two pairs 8a and 8b, i.e., the pair 8a of the imaging apparatus 12a and information processing apparatus 10a and the pair 8b of the imaging apparatus 12b and information processing apparatus 10b. However, the number of the pairs is not limited to any specific number. The position and posture information obtained in each of the camera coordinate systems is aggregated by a predetermined information processing apparatus 10a. This information processing apparatus 10a collects the position and posture information acquired on its own and from the other information processing apparatus 10b, thereby generating the position and posture information in the world coordinate system. The information processing apparatus 10a then performs predetermined information processing on the resulting position and posture information so as to generate output data such as images and sounds.

In the description that follows, the information processing apparatus 10a that collects the position and posture information in the camera coordinate systems, transforms the collected information into the final position and posture information, and performs predetermined information processing using the generated information may be referred to as “information processing apparatus 10a having the main functions,” and any other information processing apparatus as “information processing apparatus having the sub functions.”

The content of processes performed by the information processing apparatus 10a having the main functions using the position and posture information is not limited to anything specific and may be determined in accordance with the functions or the content of applications desired by the user. The information processing apparatus 10a may acquire the position and posture information regarding the HMD 18 in the manner described above, for example, thereby implementing a virtual reality by rendering it in the field of view in accordance with the user's line of sight. Further, the information processing apparatus 10a may identify the motions of the user's head and hands in order to advance games in which characters or the items reflecting the identified motions appear, or so as to convert the user's motions into command input for information processing. The information processing apparatus 10a having the main functions outputs the generated output data to a display apparatus such as the HMD 18.

The HMD 18 is a display apparatus that presents the user wearing it with images on a display panel such as an organic EL panel positioned in front of the user's eyes. For example, parallax images acquired from right and left points of views are generated and displayed on a right and a left display region bisecting the display screen to let the images be viewed stereoscopically. However, this is not limitative of the embodiment of the present invention. Alternatively, a single image may be displayed over the entire display screen. The HMD 18 may further incorporate speakers or earphones that output sounds to the positions corresponding to the user's ears.

Incidentally, the destination to which the information processing apparatus 10a having the main functions outputs data is not limited to the HMD 18. The destination of the data output may alternatively be a flat-screen display, not illustrated.

The communication between the information processing apparatuses 10a and 10b on one hand and the corresponding imaging apparatuses 12a and 12b on the other hand, between the information processing apparatus 10a having the main functions on one hand and the information processing apparatus 10b having the sub functions on the other hand, and between the information processing apparatus 10a having the main functions on one hand and the HMD 18 on the other hand, may be implemented either by cable such as Ethernet (registered trademark) or wirelessly such as by Bluetooth (registered trademark). The external shapes of these apparatuses are not limited to those illustrated. For example, the imaging apparatus 12a and the information processing apparatus 10a may be integrated into an information terminal, and so may be the imaging apparatus 12b and the information processing apparatus 10b.

Further, the apparatuses may each be provided with an image display function, and images generated in accordance with the position and posture of the target may be displayed by each apparatus. With this embodiment, as described above, the pairs 8a and 8b of the information processing apparatuses and imaging apparatuses acquire the position and posture information regarding the target in the camera coordinate systems. Whereas the target is not limited to anything specific because the process involved may be implemented using existing techniques, the description that follows assumes that the HMD 18 is the target.

FIG. 2 depicts an exemplary external shape of the HMD 18. In this example, the HMD 18 is configured with an output mechanism section 102 and a wearing mechanism section 104. The wearing mechanism section 104 includes a wearing band 106 that encircles the head and attaches the apparatus thereto when worn by the user. The wearing band 106 may be made of such a material or have such a structure that its length can be adjusted according to the circumference of the user's head. For example, the wearing band 106 may be made of an elastic body such as rubber or may be structured using a buckle or gear wheels.

The output mechanism section 102 includes a housing 108 shaped in such a manner as to cover the right and left eyes when the user wears the HMD 18. Inside the output mechanism section 102 is a display panel directly facing the eyes when worn. Disposed on the outer surface of the housing 108 are markers 110a, 110b, 110c, 110d, and 110e that are lit in a predetermined color. The number of markers, their arrangements, and their shapes are not limited to anything specific. In the illustrated example, approximately rectangular markers are provided in the four corners and at the center of the output mechanism section 102.

Further, both rear sides of the wearing band 106 are provided with elliptically shaped markers 110f and 110g. On the basis of their number and their positions, the markers thus arranged permit identification of situations in which the user faces sideways or backwards relative to the imaging apparatuses 12a and 12b. Incidentally, the markers 110d and 110e are disposed under the output mechanism section 102 and the markers 110f and 110g are outside the wearing band 116, so that their contours are indicated by dotted lines because the markers are invisible from points of view in FIG. 2. The markers need only have predetermined colors and shapes and be configured to be distinguishable from the other objects in an imaging space. In some cases, the markers need not be lit.

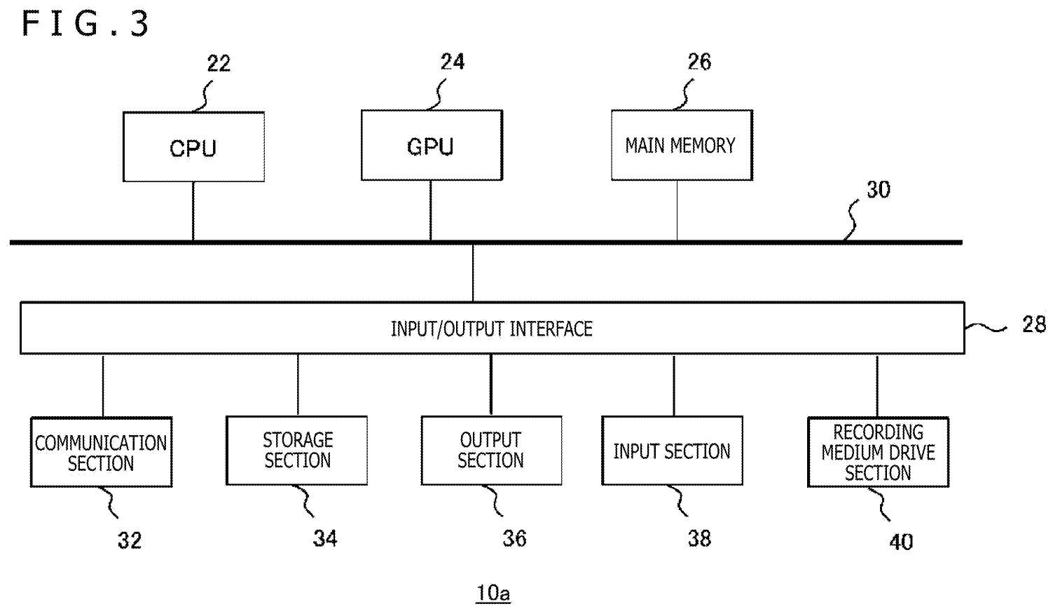

FIG. 3 depicts an internal circuit configuration of the information processing apparatus 10a having the main functions. The information processing apparatus 10a includes a CPU (Central Processing Unit) 22, a GPU (Graphics Processing Unit) 24, and a main memory 26. These components are interconnected via a bus 30. The bus 30 is further connected with an input/output interface 28. The input/output interface 28 is connected with a peripheral device interface such as a USB (universal serial bus) or IEEE (Institute of Electrical and Electronics Engineers) 1394 port, a communication section 32 including a wired or wireless LAN (local area network) network interface, a storage section 34 including a hard disk drive or a nonvolatile memory, an output section 36 that outputs data to the information processing apparatus 10b having the sub functions and to the HMD 18, an input section 38 that receives input of data from the information processing apparatus 10b, from the imaging apparatus 12, and from the HMD 18, and a recording medium drive section 40 that drives removable recording media such as magnetic disks, optical disks, or semiconductor memories.

The CPU 22 controls the information processing apparatus 10a as a whole by executing an operating system stored in the storage section 34. Further, the CPU 22 performs various programs read from the removable recording media or downloaded via the communication section 32 and loaded into the main memory 26. The GPU 24 has the functions of both a geometry engine and a rendering processor. Under rendering instructions from the CPU 22, the GPU 24 performs rendering processes and stores resulting display image into a frame buffer, not depicted.

The display image stored in the frame buffer is converted to a video signal before being output to the output section 36. The main memory 26 is configured with a RAM (Random Access Memory) that stores programs and data necessary for processing. The information processing apparatus 10b having the sub functions has basically the same internal circuit configuration. It is to be noted, however, that in the information processing apparatus 10b, the input section 38 receives input of data from the information processing apparatus 10a and the output section 36 outputs the position and posture information in the camera coordinate system.

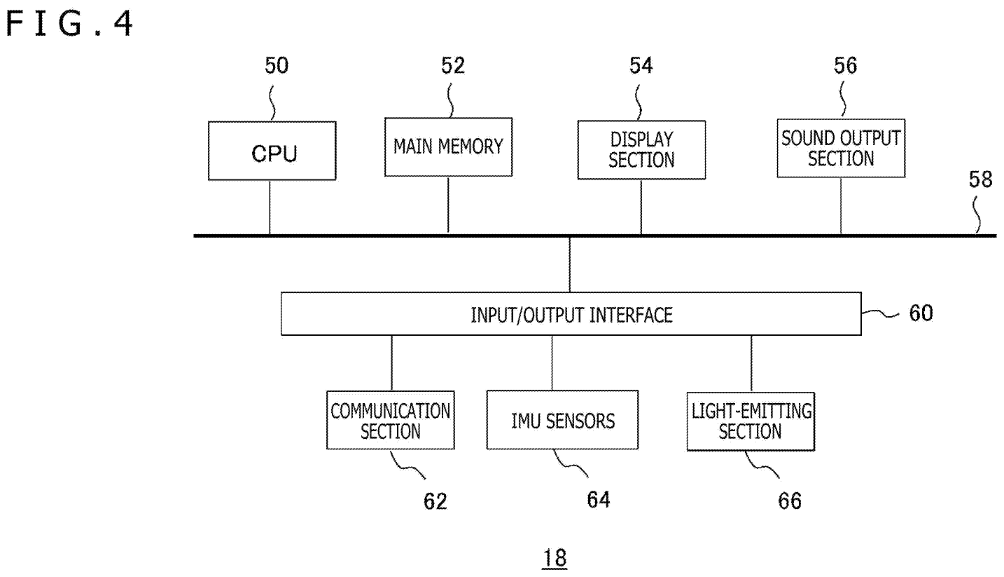

FIG. 4 depicts an internal circuit configuration of the HMD 18. The HMD 18 includes a CPU 50, a main memory 52, a display section 54, and a sound output section 56. These components are interconnected via a bus 58. The bus 58 is further connected with an input/output interface 60. The input/output interface 60 is connected with a communication section 62 including a wired or wireless LAN network interface, IMU (inertial measurement unit) sensors 64, and a light-emitting section 66.

The CPU 50 processes information acquired from the components of the HMD 18 via the bus 58, and supplies output data acquired from the information processing apparatus 10a having the main functions to the display section 54 and to the sound output section 56. The main memory 52 stores the programs and data required by the CPU 50 for processing. Depending on the application to be executed or on the design of the apparatus, there may be a case where the information processing apparatus 10a performs almost all processing so that the HMD 18 need only output the data transmitted from the information processing apparatus 10a. In this case, the CPU 50 and the main memory 52 may be replaced with more simplified devices.

The display section 54, configured with a display panel such as a liquid crystal panel or an organic EL panel, displays images before the eyes of the user wearing the HMD 18. As described above, a pair of parallax images may be displayed on the display regions corresponding to the right and left eyes so as to implement stereoscopic images. The display section 54 may further include a pair of lenses positioned between the display panel and the eyes of the user wearing the HMD 18, the paired lenses serving to extend the viewing angle of the user.

The sound output section 56 is configured with speakers or earphones positioned corresponding to the ears of the user wearing the HMD 18, the speakers or earphones outputting sounds for the user to hear. The number of channels on which sounds are output is not limited to any specific number. There may be monaural, stereo, or surround channels. The communication section 62 is an interface that transmits and receives data to and from the information processing apparatus 10a, the interface being implemented using known wireless communication technology such as Bluetooth (registered trademark). The IMU sensors 64 include a gyro sensor and an acceleration sensor and acquire angular velocity and acceleration of the HMD 18. The output values of the sensors are transmitted to the information processing apparatus 10a via the communication section 62. The light-emitting section 66 is an element or an aggregate of elements emitting light in a predetermined color. As such, the light-emitting section 66 constitutes the markers disposed at multiple positions on the outer surface of the HMD 18 depicted in FIG. 2.

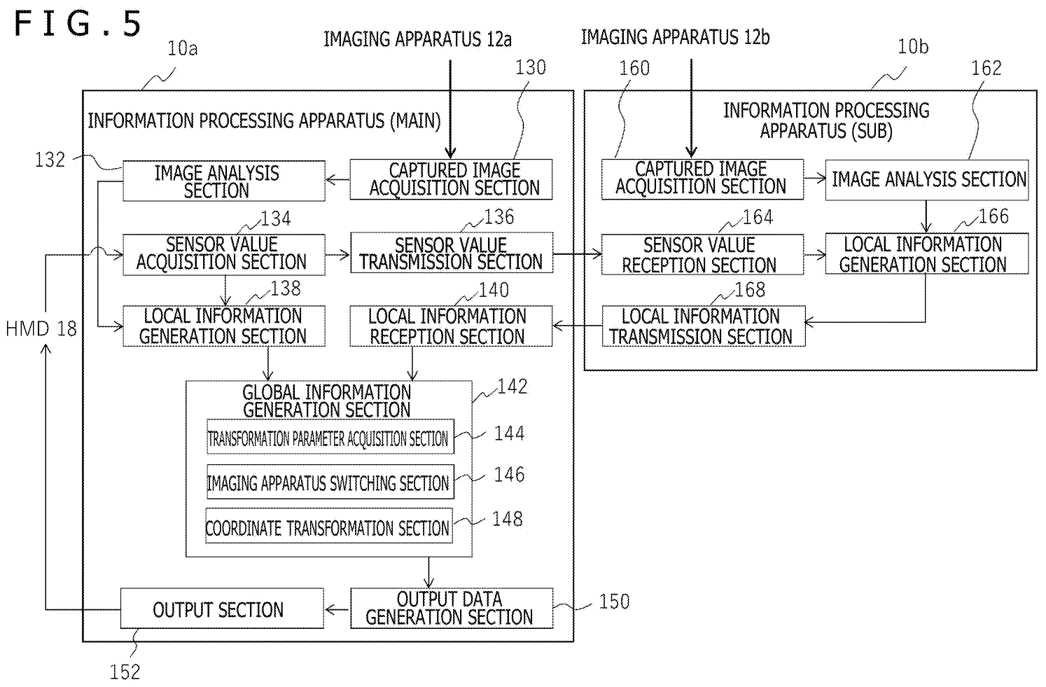

FIG. 5 depicts a configuration of functional blocks in the information processing apparatus 10a having the main functions and a configuration of functional blocks in the information processing apparatus 10b having the sub functions. The functional blocks depicted in FIG. 5 may be implemented in hardware using the CPU, GPU, and memory depicted in FIG. 3, for example, or implemented in software using programs that are loaded typically from recording media into memory to provide such functions as data input, data retention, image processing, and input/output. Thus, it will be understood by those skilled in the art that these functional blocks are implemented in hardware alone, in software alone, or by a combination of both in diverse forms and are not limited to any of such forms.

The information processing apparatus 10a having the main functions includes a captured image acquisition section 130 that acquires data representing captured images from the imaging apparatus 12a, an image analysis section 132 that acquires position and posture information based on the captured images, a sensor value acquisition section 134 that acquires the output values of the IMU sensors 64 from the HMD 18, a sensor value transmission section 136 that transmits the output values of the IMU sensors 64 to the information processing apparatus 10b having the sub functions, and a local information generation section 138 that generates position and posture information in the camera coordinate system by integrating the output values of the IMU sensors 64 and the position and posture information based on the captured images. The information processing apparatus 10a further includes a local information reception section 140 that receives the position and posture information transmitted from the information processing apparatus 10b having the sub functions, a global information generation section 142 that generates position and posture information in the world coordinate system, an output data generation section 150 that generates output data by performing information processing using the position and posture information, and an output section 152 that transmits the output data to the HMD 18.

The captured image acquisition section 130 is implemented using the input section 38, CPU 22, and main memory 26 in FIG. 3, for example. The captured image acquisition section 130 acquires sequentially the data of captured images output by the imaging apparatus 12a at a predetermined frame rate, and supplies the acquired data to the image analysis section 132. In the case where the imaging apparatus 12a is configured with a stereo camera, the data of images captured by right and left cameras is acquired sequentially. The captured image acquisition section 130 may be arranged to control the start and end of image capture by the imaging apparatus 12a in accordance with processing start/end requests acquired from the user via an input apparatus or the like, not depicted.

The image analysis section 132 is implemented using the CPU 22, GPU 24, and main memory 26 in FIG. 3, for example. The image analysis section 132 acquires the position and posture information regarding the HMD 18 at a predetermined rate by detecting images of the markers disposed on the HMD 18 from the captured image. In the case where the imaging apparatus 12a is configured with a stereo camera, the distance from the imaging plane to each of the markers is obtained by the principle of triangulation on the basis of the parallax between corresponding points acquired from right and left images. Then, by integrating the information regarding the positions of multiple captured markers in the image and the information regarding the distances to the markers, the image analysis section 132 estimates the position and posture of the HMD 18 as a whole.

The target is not limited to the HMD 18 as discussed above. The position and posture information regarding the user's hand as the target may be acquired on the basis of images of light-emitting markers disposed on the input apparatus, not depicted. Further, it is possible to use in combination the techniques of image analysis for tracking a part of the user's body using contour lines and for recognizing the face or the target having a specific pattern through pattern matching. Depending on the configuration of the imaging apparatus 12a, the distance to the target may be identified by measuring the reflection of infrared rays as described above. That is, the techniques of image analysis are not limited to anything specific as long as they serve to acquire the position and posture of a subject through image analysis.

The sensor value acquisition section 134 is implemented using the input section 38, communication section 32, and main memory 26 in FIG. 3, for example. The sensor value acquisition section 134 acquires the output values of the IMU sensors 64, i.e., angular velocity and acceleration data, from the HMD 18 at a predetermined rate. The sensor value transmission section 136 is implemented using the output section 36 and communication section 32 in FIG. 3, for example. The sensor value transmission section 136 transmits the output values of the IMU sensors 64 to the information processing apparatus 10b at a predetermined rate, the output values having been acquired by the sensor value acquisition section 134.

The local information generation section 138 is implemented using the CPU 22 and main memory 26 in FIG. 3, for example. The local information generation section 138 generates the position and posture information regarding the HMD 18 in the camera coordinate system of the imaging apparatus 12a using the position and posture information acquired by the image analysis section 132 and the output values of the IMU sensors 64. In the description that follows, the position and posture information obtained in the camera coordinate system specific to each imaging apparatus will be referred to as “local information.” The acceleration and angular velocity on the three axes represented by the output values of the IMU sensors 64 are integrated for use in obtaining the amounts of change in the position and posture of the HMD 18.

The local information generation section 138 estimates a subsequent position and posture of the HMD 18 using the position and posture information regarding the HMD 18 identified at the time of the preceding frame and the changes in the position and posture of the HMD 18 based on the output values of the IMU sensors 64. By integrating the estimated position and posture information and the information regarding the position and posture obtained through analysis of captured images, the local information generation section 138 identifies with high accuracy the information regarding the position and position at the time of the next frame. The techniques for status estimation that use the Kalman filter and are known in the field of computer vision may be applied to this process.

The local information reception section 140 is implemented using the communication section 32 and input section 38 in FIG. 3, for example. The local information reception section 140 receives local information generated by the information processing apparatus 10b having the sub functions. The global information generation section 142 is implemented using the CPU 22 and main memory 26 in FIG. 3, for example. The global information generation section 142 generates the position and posture information regarding the HMD 18 in the world coordinate system independent of the imaging apparatuses 12a and 12b using at least either the local information generated by the local information generation section 138 in the own apparatus or the local information transmitted from the information processing apparatus 10b having the sub functions. In the description that follows, the position and posture information thus generated will be referred to as “global information.”

More specifically, the global information generation section 142 includes a transformation parameter acquisition section 144, an imaging apparatus switching section 146, and a coordinate transformation section 148. The transformation parameter acquisition section 144 acquires transformation parameters for transforming the position and posture information in each camera coordinate system into the world coordinate system by identifying the position and posture information regarding the imaging apparatuses 12a and 12b in the world coordinate system. The acquisition, at this time, of the transformation parameters takes advantage of the fact that if the HMM 18 is found in a region where the fields of view of the imaging apparatuses 12a and 12b overlap with each other (the region will be referred to as “field-of-view overlap region” hereunder), the local information obtained in the camera coordinate systems of both imaging apparatuses proves to be the same when transformed into global information.

When the transformation parameters are derived using the local information actually obtained during operation, the coordinate transformation is accomplished advantageously by taking into consideration error characteristics that may occur upon generation of the local information by each of the information processing apparatuses 10a and 10b. Another advantage is that there is no need to position the imaging apparatuses 12a and 12b with high precision where they are arranged. Also, the transformation parameter acquisition section 144 gradually corrects the transformation parameters in such a manner that the position and posture information thus obtained regarding the imaging apparatuses 12a and 12b in the world coordinate system of will be smoothed in the time direction or that their posture values will approach normal values.

The imaging apparatus switching section 146 switches the imaging apparatuses whose fields of view cover the HMD 18 to select the imaging apparatus for use in acquiring global information. In the case where the HMD 18 is found only in the image captured by one imaging apparatus, the global information is obviously generated using the local information generated by the information processing apparatus corresponding to that imaging apparatus. In the case where the HMD 18 is found in the fields of view of multiple imaging apparatuses, one of them is selected in accordance with predetermined rules. For example, the imaging apparatus closest to the HMD 18 is selected, and the global information is generated using the local information generated by the information processing apparatus corresponding to the selected imaging apparatus.

The coordinate transformation section 148 generates the global information by performing a coordinate transformation on the local information generated by the information processing apparatus corresponding to the selected imaging apparatus. At this point, using the transformation parameters, generated by the transformation parameter acquisition section 144, corresponding to the selected imaging apparatus allows the coordinate transformation section 148 to obtain accurately the position and posture information independent of the imaging apparatuses constituting the sources of information.

The output data generation section 150 is implemented using the CPU 22, GPU 24, and main memory 26 in FIG. 3, for example. The output data generation section 150 performs predetermined information processing using the global information, output by the global information generation section 142, regarding the position and posture of the HMD 18. As a result of this, the output data generation section 150 generates the data of images and sounds to be output at a predetermined rate. For example, a virtual world as viewed from the point of view corresponding to the position and posture of the user's head is rendered as right and left parallax images, as discussed above.

The output section 152 is implemented using the output section 36 and communication section 32 in FIG. 3, for example. The output section 152 outputs the data of generated images and sounds to the HMD 18 at a predetermined rate. For example, if the above-mentioned parallax images are presented before the right and left eyes of the user wearing the HMD 18 together with output sounds from the virtual world, the user gets the feeling as if he or she is inside the virtual world. Incidentally, the data generated by the output data generation section 150 need not be the data of display images and sounds. Alternatively, the information regarding the user's motions and gestures obtained from the global information may be generated as output data that is output to a separately provided information processing function. In this case, the information processing apparatus 10a in the illustration functions as a status detection apparatus for detecting the status of the target such as the HMD 18.

The information processing apparatus 10b having the sub functions includes a captured image acquisition section 160 that acquires the data of captured images from the imaging apparatus 12b, an image analysis section 162 that acquires position and posture information based on the captured images, a sensor value reception section 164 that receives the output values of the IMU sensors 64 from the information processing apparatus 10a, a local information generation section 166 that generates local information by integrating the position and posture information based on the captured images and the output values of the IMU sensors 64, and a local information transmission section 168 that transmits the local information to the information processing apparatus 10a.

The captured image acquisition section 160, image analysis section 162, and local information generation section 166 have the same functions as those of the captured image acquisition section 130, image analysis section 132, and local information generation section 138 respectively in the information processing apparatus 10a having the main functions. The sensor value reception section 164 is implemented using the communication section 32 and input section 38 in FIG. 3, for example. The sensor value reception section 164 receives at a predetermined rate the output values of the IMU sensors 64 transmitted from the information processing apparatus 10a. The local information transmission section 168 is implemented using the output section 36 and communication section 32 in FIG. 3, for example. The local information transmission section 168 transmits the local information generated by the local information generation section 166 to the information processing apparatus 10a.

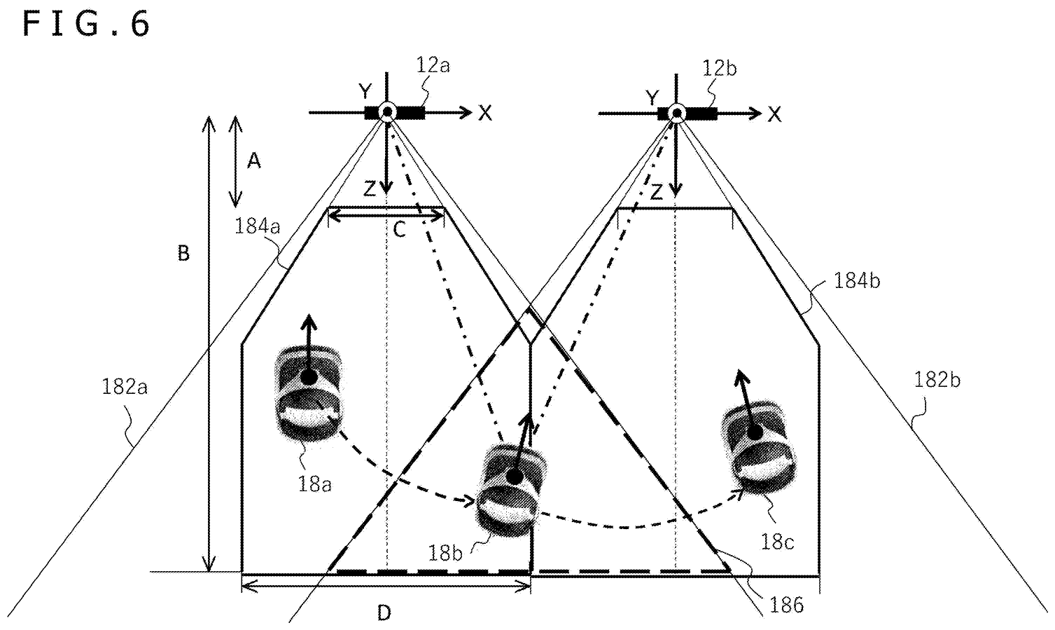

FIG. 6 depicts relations between the arrangement of the imaging apparatuses 12a and 12b on one hand and the movable range of the HMD 18 on the other hand. FIG. 6 gives a bird's-eye view of fields of view 182a and 182b of the imaging apparatuses 12a and 12b. In order to accurately acquire position and posture information using captured images, it is necessary for the images to be presented at appropriate positions in appropriate sizes. For this reason, the ranges in which the HMD 18 is preferably found are to be smaller than the fields of view 182a and 182b. The preferred ranges are indicted as play areas 184a and 184b in the drawing.

The play areas 184a and 184b are delimited, in the front-back direction, for example, by an extent ranging from a distance A of approximately 0.6 m from the imaging apparatus 12a to a distance B of approximately 3 m therefrom, by a width C of approximately 0.7 m in the crosswise direction closest to the imaging apparatus 12a, and by a width D of approximately 1.9 m in the crosswise direction farthest from the imaging apparatus 12a. The camera coordinate systems of the imaging apparatuses 12a and 12b are each defined by the optical center as the origin, by an X axis representing the imaging plane oriented right in the crosswise direction, by a Y axis representing the imaging plane oriented upward in the longitudinal direction, and by a Z axis representing the imaging plane oriented in the vertical direction. According to existing techniques, the position and posture of the HMD 18 in the play area (e.g., play area 184a) of one imaging apparatus (e.g., imaging apparatus 12a) are obtained using the camera coordinate system of that imaging apparatus.

In this embodiment, the play areas are extended by providing multiple such systems. When the imaging apparatuses 12a and 12b are arranged in such a manner that their play areas are contiguous to each other as illustrated, the overall play area is doubled in size. It is to be noted, however, that these multiple play areas need only be continuous and that the imaging apparatuses 12a and 12b need not be arranged so that their play areas are precisely adjacent to each other. As described above, the information processing apparatus 10a corresponding to the imaging apparatus 12a generates the local information constituted by the position and posture of the HMD 18 in the camera coordinate system of the imaging apparatus 12a.

The information processing apparatus 10b corresponding to the imaging apparatus 12b generates the local information constituted by the position and posture of the HMD 18 in the camera coordinate system of the imaging apparatus 12b. Consider an example in which the HMD moves from the position of an HMD 18a to the position of an HMD 18b to the position of an HMD 18c, as illustrated. When the HMD is in the play area 184a of the imaging apparatus 12a as in the case of the HMD 18a, the local information obtained in the camera coordinate system of the imaging apparatus 12a is transformed into global information. When the HMD is in the play area 184b of the imaging apparatus 12b as in the case of the HMD 18c, the local information obtained in the camera coordinate system of the imaging apparatus 12b is transformed into global information.

When the HMD is in a field-of-view overlap region 186 between the imaging apparatuses 12a and 12b while moving from the play area 184a to the play area 184b as in the case of the HMD 18b, the imaging apparatus as the source of local information for use in generating global information is switched from the imaging apparatus 12a to the imaging apparatus 12b at a timing in accordance with predetermined rules. For example, the imaging apparatus switching section 146 monitors the distance between the center of gravity of the HMD 18b on one hand and each of the optical centers of the imaging apparatuses 12a and 12b on the other hand. At the time when the magnitude relation between the monitored distances is reversed, the closer imaging apparatus of the two (e.g., imaging apparatus 12b) is selected so that the local information obtained in the camera coordinate system of the selected apparatus may be used to generate global information.

Also, when the HMD is in the field-of-view overlap region 186 as in the case of the HMD 18b, the local information obtained in both camera coordinate systems should represent the same position and posture information when transformed into global in formation. This assumption is used by the transformation parameter acquisition section 144 as the basis for obtaining the parameters for transforming the local information into global information.

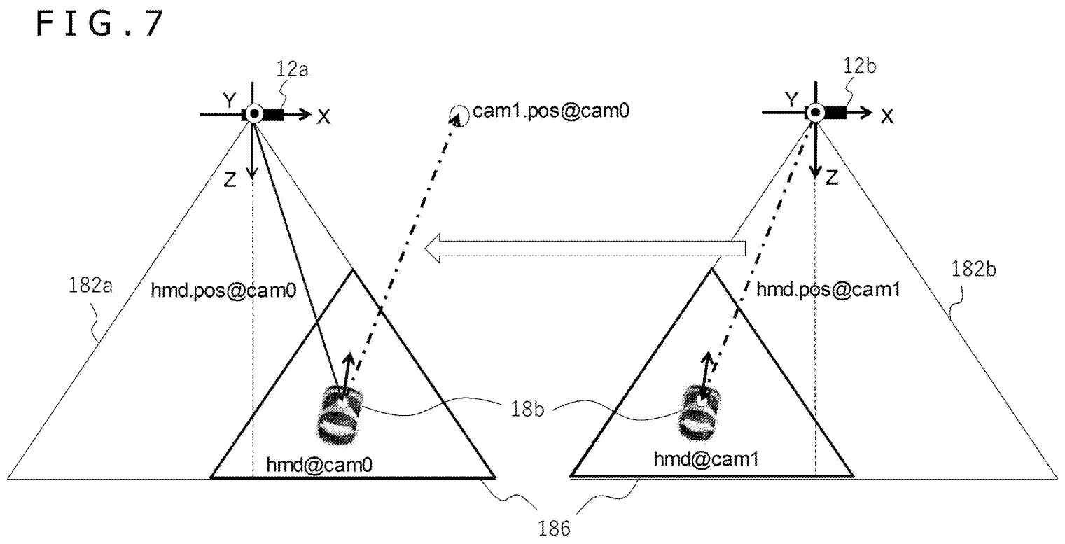

FIG. 7 is a view explaining the technique by which the transformation parameter acquisition section 144 obtains parameters for transforming local information to global information. In FIG. 7, the fields of view 182a and 182b of the imaging apparatuses 12a and 12b in FIG. 6 are separated left and right, with the HMD 18b located in the field-of-view overlap region 186. As discussed above, the position and posture of the HMD 18b in the camera coordinate system of the imaging apparatus 12a and the position and posture of the HMD 18b in the camera coordinate system of the imaging apparatus 12b are obtained independently of one another by the corresponding information processing apparatuses 10a and 10b.

Qualitatively, the origin and the rotation angles of the axes of each camera coordinate system in the world coordinate system may be used, when obtained, to transform the position and posture of the HMD 18 in the camera coordinate systems into information in the world coordinate system. This involves obtaining, first of all, the position and posture of the imaging apparatus 12b as viewed from the imaging apparatus 12a. Here, the position in three-dimensional coordinates is represented by “pos” and the quaternion indicative of the posture is noted as “quat.” A posture difference dq of the HMD 18b between the camera coordinate system of the imaging apparatus 12a (referred to as “0-th camera coordinate system” hereunder) and the camera coordinate system of the imaging apparatus 12b (referred to as “first camera coordinate system” hereunder) is calculated as follows: dq=hmd.quat@cam0*conj(hmd.quat@cma1)

In the above equation, hmd.quat@cam0 denotes the posture of the HMD 18b in the 0-th camera coordinate system, and hmd.quat@cam1 stands for the posture of the HMD 18b in the first camera coordinate system. “conj” represents the function that returns the conjugate of a complex number. The first camera coordinate system is rotated by an amount of the posture difference so as to align the posture of the HMD 18b, before the vector from the origin of the 0-th camera coordinate system to the HMD 18b and the vector from the HMD 18b to the imaging apparatus 12b are added up. This provides the position cam1.pos@cam0 of the imaging apparatus 12b in the 0-th camera coordinate system as illustrated.

cam1.pos@cam0=rotate(dq,-hmd.pos@cam1)+hmd.pos@cam0 where, “rotate” is the function for rotating coordinates around the origin.

If the position and posture information cam0@world regarding the imaging apparatus 12a in the world coordinate system is already known, then the position and posture information cam1@world regarding the imaging apparatus 12b in the world coordinate system is obtained by transforming the position cam1.pos@cam0 and the posture dq of the imaging apparatus 12b in the 0-th camera coordinate system further into data in the world coordinate system. The calculations involved may be common 4×4 affine transformation matrix operations. In the case where the 0-th camera coordinate system is used uncorrected as the world coordinate system, the position of the imaging apparatus 12a is given as cam0.pos@world=(0, 0, 0) and the posture as cam0.quat@world=(0, 0, 0, 1).

When the position cam1.pos@world of the imaging apparatus 12b and its posture cam1.quat@world in the world coordinate system are obtained in the manner described above, it is possible to transform the position hmd.pos@cam1 of a given HMD and the posture hmd.quat@cam1 thereof in the first camera coordinate system of the imaging apparatus 12b into a position hmd.pos@world and a posture hmd.quad@world in the world coordinate system.

hmd.quat@world=cam1.quat@world*hmd.quat@cam1
hmd.pos@world=rotate(cam1.quat@world,hmd.pos@cam1)+cam1.pos@world

Alternatively, the position and posture information regarding the imaging apparatus 12b in the world coordinate system may be obtained collectively by affine transformation. That is, a 4×4 matrix representative of the position and posture information hmd@cam0 regarding the HMD 18b in the 0-th camera coordinate system, of the position and posture information hmd@cam1 regarding the HMD 18b in the first camera coordinate system, and of the position and posture information cam0@world regarding the imaging apparatus 12a in the world coordinate system is used to obtain a matrix cam1mat of the position and posture information cam1@world regarding the imaging apparatus 12b in the world coordinate system as follows:

cam0to1mat=hmd0mat*inverse(hmd1mat)
cam1mat=cam0mat*cam0to1mat
where, “inverse” is the function for obtaining an inverse matrix.

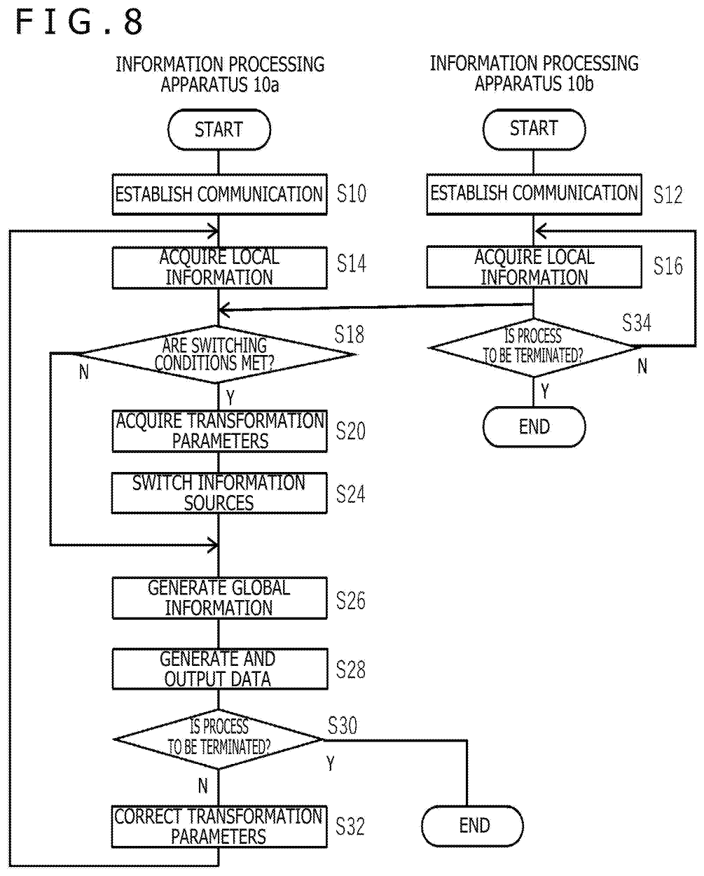

Explained below is the operation of the information processing apparatuses implemented by use of the configurations described above. FIG. 8 is a flowchart depicting the processing procedure in which the information processing apparatuses 10a and 10b according to the embodiment acquire the position and posture information regarding the target in order to generate and output data reflecting the acquired information. The procedure of the flowchart is started when the corresponding imaging apparatuses 12a and 12b start their image capture and the user wearing the HMD 18 as the target is in the field of view of one of the imaging apparatuses. First, typically in accordance with the user's operations via an input apparatus, not depicted, communication is established between the information processing apparatus 10a and the corresponding imaging apparatus 12a, and communication is also established between the information processing apparatus 10b and the corresponding imaging apparatus 12b (S10 and S12). At this time, the information processing apparatus 10a having the main functions also establishes communication with the HMD 18.

With the communication established, the imaging apparatuses 12a and 12b transmit the data of captured images and the HMD 18 transmits the output values of the IMU sensors 64. This causes the local information generation sections 138 and 166 in the information processing apparatuses 10a and 10b to generate the position and posture information regarding the HMD 18 in their respective camera coordinate systems (S14 and S16). When the HMD 18 is not in the field of view of a given imaging apparatus at this point, the corresponding information processing apparatus generates invalid data. The information processing apparatus 10b having the sub functions transmits the generated local information to the information processing apparatus 10a having the main functions.

In the case where multiple sets of local information include valid data as the position and posture information regarding the HMD 18, that means the HMD 18 is in the field-of-view overlap region. During this period, the imaging apparatus switching section 146 in the information processing apparatus 10a having the main functions monitors whether or not the HMD 18 meets predetermined switching conditions (S18). For example, in the case where the HMD 18 in the field of view of the imaging apparatus 12a moves out of it and into the field of view of the imaging apparatus 12b as depicted in FIG. 6, the selection of the imaging apparatus 12b as the source of information is determined at the time the center of gravity of the HMD 18 comes closer to the optical center of the imaging apparatus 12b than to that of the imaging apparatus 12a.

Another condition for switching the source of information may be the time when the center of gravity of the HMD 18 moves into the play area of an adjacent imaging apparatus. Qualitatively, the imaging apparatus 12 capable of acquiring the position and posture information regarding the HMD 18 with higher accuracy than any other imaging apparatus is selected as the source of information. When such switching conditions are met (Y in S18), the transformation parameter acquisition section 144 in the information processing apparatus 10a first acquires the transformation parameters for the camera coordinate system of the imaging apparatus whose field of view has started to cover the HMD 18 anew (S20).

Specifically, as discussed above, when the local information acquired by each of the information processing apparatuses is transformed into global information, the transformation parameters for the camera coordinate system of the destination imaging apparatus are acquired in such a manner that the positions and postures provided by the information processing apparatuses coincide with one another. The transformation parameter acquisition section 144 stores the acquired transformation parameters in an internal memory in association with information for identifying the imaging apparatus. The imaging apparatus switching section 146 proceeds to select the imaging apparatus serving as the source of the local information that is to be transformed into global information in the manner described above (S24).

In the case where the HMD 18 does not meet the switching conditions (N in S18) or where the HMD 18 has met the switching conditions causing the sources of information switched (S24), the coordinate transformation section 148 generates the global information by transforming in coordinates the local information from the currently determined source of information (S26). Used at this time are the transformation parameters held by the transformation parameter acquisition section 144 in the internal memory in association with the imaging apparatus serving as the source of information. The output data generation section 150 generates data such as display images using the global information. The output section 152 outputs the generated data to the HMD 18 (S28). Because the global information is independent of the imaging apparatus serving as the source of information, the output data generation section 150 can generate the output data through similar processing.

If it is not necessary to terminate the process by the user's operation, for example (N in S30 or N in S34), the transformation parameter acquisition section 144 corrects as needed the transformation parameters acquired in S20 (S32). Thereafter, the information processing apparatus 10a having the main functions repeats the processing in S14 to S28 and in S32, and the information processing apparatus 10b having the sub function repeats the processing in S16, at a predetermined rate each.

When the information processing apparatuses generate the local information, they can determine the position and posture information with a minimum of errors by additionally using the position and posture information regarding the HMD 18 estimated from the output values of the IMU sensors 64 in the HMD 18, as discussed above. This measure is taken to deal with the fact that errors are included both in the position and posture information obtained from the captured images and in the position and posture information acquired from the IMU sensors 64. The local information that integrates these sets of information also includes minute errors. The transformation parameters acquired in S20 can potentially include minute errors also because these parameters are based on the local information.

For that reason, the transformation parameters are to be acquired and corrected as needed. The local information obtained immediately after such correction is then transformed into global information with the fewest possible errors. On the other hand, at a time when the imaging apparatus as the source of information is switched in S24, even a little deviation of the axes of the world coordinate system before and after the switchover can cause a discontinuous change in the field of view of the display image generated by use of the world coordinate system. Such a change can give the user an uncomfortable feeling. Thus, in S20 immediately before the switching of the imaging apparatus as the source of information, the local information in each of the camera coordinate systems at that point in time is compared with each other as discussed above. The comparison of the local information enables the transformation parameters to be acquired in such a manner that the world coordinate system after the transformation fully coincides with the preceding world coordinate system.

As a result of giving priority to such continuity, the position and posture of the imaging apparatus represented by the transformation parameters acquired in S20 may conceivably include relatively large errors. The transformation parameters, if used uncorrected, can lead to errors accumulating in the position and posture information regarding the HMD 18 and can even cause the origin of the world coordinate system to be displaced or tilted. Thus, in S32 as a period other than the switching timing for the imaging apparatuses, the transformation parameter acquisition section 144 gradually corrects the transformation parameters acquired in S20 upon switching of the imaging apparatuses.

That is, the transformation parameters are corrected in a manner reflecting the actual positions and postures of the imaging apparatuses. The techniques of correction may be varied depending on the characteristics of the imaging apparatuses. For example, in the case where the imaging apparatuses 12a and 12b are fixed, the transformation parameters are corrected in such a manner that the positions and postures represented by the transformation parameters become averages of the positions and postures obtained so far. In the case where the imaging apparatuses 12a and 12b are fixed, with the longitudinal direction of their imaging planes coinciding with the vertical direction of the real space, the postures represented by the transformation parameters are corrected in such a manner that the Y axes of the imaging apparatuses 12a and 12b are in the reverse direction of gravity. The direction of gravity is obtained on the basis of the output values of the IMU sensors 64 in the HMD 18.

In the case where the imaging apparatuses 12a and 12b are not fixed, the positions and postures obtained so far are smoothed in the time direction. This determines the target values for the positions and postures represented by the transformation parameters. When the camera coordinate system of the imaging apparatus 12a corresponding to the information processing apparatus 10a having the main functions is taken as the world coordinate system, the transformation parameters are corrected in a manner making the origins and axes of the two systems coincide with one another. Such corrections are carried out gradually in multiple steps in such a manner that the user, presented with the generated display images, will not notice. For example, the upper limits of correction amounts per unit time may be obtained beforehand by experiments, and the number of times correction to be separately performed may be determined in accordance with the actually required correction amounts. Upon completion of the corrections, the processing in S32 may be omitted.

Repeating the processing in S14 to S32 permits continuous output of images through similar processing regardless of the imaging apparatus whose field of view currently covers the user wearing the HMD 18. If it becomes necessary to terminate the process typically by the user's operation, the whole processing is terminated (Y in S30 or Y in S34). A similar processing procedure basically applies to the case where three or more imaging apparatuses are configured. In such a case, however, the switching of the sources of information may conceivably be performed between imaging apparatuses excluding the imaging apparatus 12a corresponding to the information processing apparatus 10a having the main functions.

At that time, the above-described techniques are used directly to acquire the position and posture information regarding the post-switching imaging apparatus in the camera coordinate system of the pre-switching imaging apparatus. Meanwhile, the position and posture information regarding the pre-switching imaging apparatus in the world coordinate system is supposed to have been obtained by the cascading switching of imaging apparatuses relative to the displacement so far of the HMD 18. As a result, the position and posture information regarding the post-switching imaging apparatus in the world coordinate system, as well as the transformation parameters eventually, can be indirectly obtained in a continuation of the cascading switching.

The above-described processing procedure includes two processes: a process in which the information processing apparatus 10a having the main functions transmits the output values of the IMU sensors 64 to the information processing apparatus 10b having the sub functions, and a process in which the information processing apparatus 10b having the sub functions transmits the local information to the information processing apparatus 10a having the main functions. In a system such as this embodiment in which the result of tracking the target is reflected in the output data in real time, it is particularly important to align the time axes of diverse data from the point of view of processing accuracy.

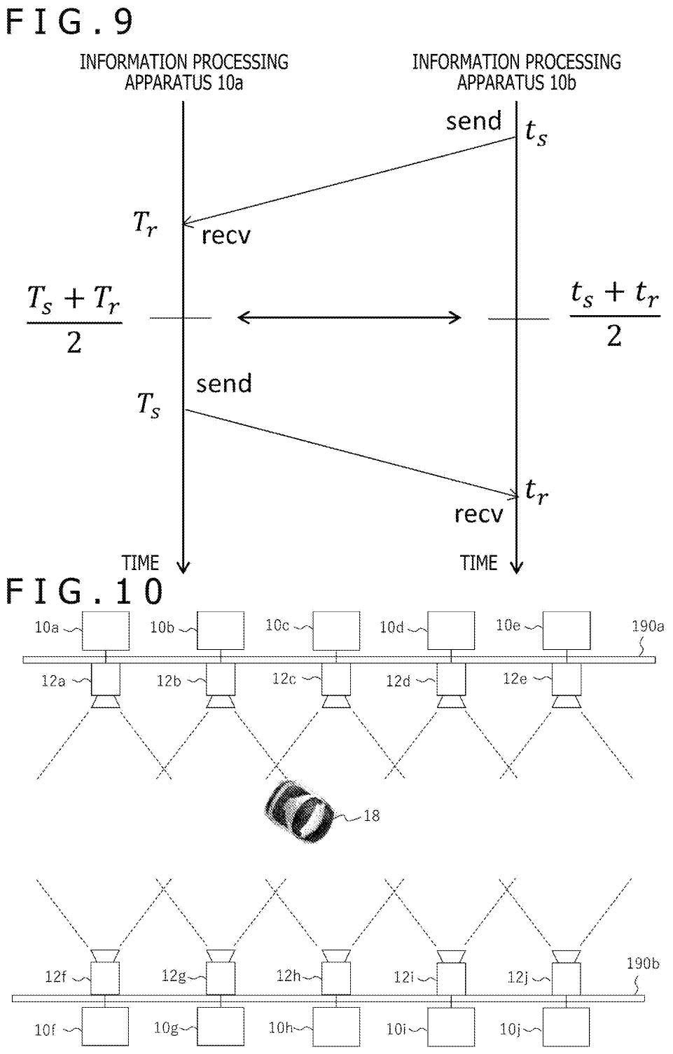

However, since the information processing apparatuses 10a and 10b operate in their respective process times, the timestamps added by the source information processing apparatus cannot be applied unmodified to the time axis of the own apparatus. Thus, the difference in process time between the information processing apparatuses 10a and 10b is measured so that timestamps may be reciprocally transformed therebetween. FIG. 9 is a view explaining a technique of reciprocal transformation of timestamps between the information processing apparatuses 10a and 10b. In FIG. 9, the axis of the process time of the information processing apparatus 10a is indicated by a downward arrow on the left, and the axis of the process time of the information processing apparatus 10b is indicated by another downward arrow on the right. The timestamp on the time axis of the information processing apparatus 10a is represented by “T,” and the timestamp on the time axis of the information processing apparatus 10b is represented by “t.”

This technique is used basically to obtain the parameters for transforming timestamps from the difference in time between the transmission and reception of test signals in round-trip propagation. In FIG. 9, a signal transmitted from the information processing apparatus 10b at time is is received by the information processing apparatus 10a at time Tr. Then, a signal transmitted from the information processing apparatus 10a at time Ts is received by the information processing apparatus 10b at time tr. At this point, if the time of the outward transmission is equal to the time of the inward transmission, the mean values of the transmission and reception times of both information processing apparatuses, i.e., (Ts+Tr)/2 and (ts+tr)/2, coincide with each other.

Making at least two measurements using the above relationship provides transform expressions for aligning the timestamps of one information processing apparatus with the time axis of another information processing apparatus. For example, the following linear expression is used to transform the timestamp t of the information processing apparatus 10b into the timestamp T of the information processing apparatus 10a:

T=t*scale+offset

where, “scale” and “offset” are obtained using simultaneous equations based on two measurements.

For example, the sensor value reception section 164 in the information processing apparatus 10b having the sub functions transforms the timestamp T, which was transmitted from the information processing apparatus 10a and added to the output values of the IMU sensors 64, into the timestamp t of the own apparatus. In this manner, the time axis of the sensor output values is aligned with the time axis of the captured image analysis processing in the own apparatus. When the local information obtained as described above is to be transmitted to the information processing apparatus 10a, the local information transmission section 168 transforms the timestamp t of the applicable position information into the timestamp T of the information processing apparatus 10a, before adding the transformed timestamp to the outgoing local information.

In the manner described above, it is possible to improve the accuracy of position information and output data without increasing the processing load on the information processing apparatus 10a having the main functions. In the case where three or more imaging apparatuses are configured, similar transformation processing may be implemented by measuring the difference in process time between the information processing apparatus 10a having the main functions on one hand and any other information processing apparatus on the other hand. Incidentally, it is preferred that the errors in transform processing be minimal because such errors can affect the stability of the position and posture information. For example, an error in the above-mentioned “scale” parameter will increase progressively with time.

Thus, it is preferable to update the parameters used for transformation by measuring the difference in process time periodically using the period during which the HMD 18 is not in the field of view, for example. The difference in process time is measured between the sensor value transmission section 136 or the local information reception section 140 in the information processing apparatus 10a having the main functions on one hand, and the sensor value reception section 164 or the local information transmission section 168 in the information processing apparatus 10b having the sub functions on the other hand. The obtained parameters are retained on the side of the information processing apparatus 10b having the sub functions.

FIG. 10 depicts an exemplary arrangement of three or more pairs of the imaging apparatus 12 and the information processing apparatus 10. In this example, there are provided 10 imaging apparatuses 12a to 12j and 10 information processing apparatuses 10a to 10j corresponding thereto respectively. Of these 10 pairs, five are spaced an equal distance apart in a single row in such a manner that their imaging planes face those of the remaining five pairs arranged opposite thereto. If FIG. 10 is regarded as a bird's-eye-view, for example, suitable walls or plates 190a and 190b each installed vertically to the floor may be furnished with the pairs of the imaging apparatuses and information processing apparatuses in a manner implementing a system that captures images of the user wearing the HMD 18 from both sides. If FIG. 10 is regarded as a side view, for example, horizontally installed plates 190a and 190b, or the ceiling and the floor, may be furnished with the pairs of the imaging apparatuses and information processing apparatuses in a manner implementing a system that captures images of the user wearing the HMD 18 from above and below.

Even in these configurations, a communication mechanism, not depicted, may be used to aggregate the local information into a single information processing apparatus 10a. This makes it possible, through processing similar to what was discussed above, to let the HMD 18 display images reflecting the user moving in an extensive range. Where the imaging apparatuses 12 are arranged to face each other a few meters apart, the user leaving one group of imaging apparatuses necessarily approaches another group of imaging apparatuses. This permits stable acquisition of the position and posture information. Incidentally, the arrangements and the number of configured imaging apparatuses in the drawing are only examples and are not limitative of this invention. Alternatively, each of the plates may be furnished with the imaging apparatuses arranged in a matrix pattern. The imaging apparatuses may further be arranged in a manner encircling the movable range of the user vertically, longitudinally, and crosswise. As another alternative, the imaging apparatuses may be arranged in a curved line as in a circle, or on a curved plane as on a sphere.

In this embodiment, the information processing apparatuses 10a to 10j each generate the local information independently of one another. The generated local information is aggregated into one information processing apparatus 10a. The amount of data transmitted in this case is considerably small compared with a case where multiple imaging apparatuses are configured without being paired and the data of images captured thereby are processed by a single information processing apparatus. It follows that even where numerous apparatuses are arranged over an extensive area as illustrated, there are few problems with processing speeds or communication bands. Where data transmission and reception is implemented with wireless communication by taking advantage of the small data amount involved, it is possible to circumvent constraints on the number of input terminals as well as problems of cable routing.

In the above-described embodiment, multiple pairs of the imaging apparatuses and information processing apparatuses are provided, each pair carrying out image analysis to acquire the position and posture information regarding the target. The local information thus obtained is aggregated into a single information processing apparatus to generate the final position and posture information. Since each information processing apparatus can utilize existing techniques when acquiring the local information, the movable range of the target is extended easily with high scalability. Because the position and posture information is ultimately generated in a manner independent of imaging apparatuses, the information processing carried out using the generated position and posture information is not limited thereby.

By taking advantage of the period during which the target is in the region where the fields of view of adjacent imaging apparatuses overlap with each other, the relative position and posture information regarding these imaging apparatuses is further obtained. The acquired information is used as the basis for obtaining the parameters for transformation from each camera coordinate system to the world coordinate system. The local information is corrected when obtained by the individual information processing apparatuses taking into consideration their current error characteristics. Because the transformation parameters are acquired using the actual local information, the position and posture information is obtained constantly with higher accuracy than if the transformation parameters acquired beforehand through calibration, for example, are utilized.

Upon switching of the imaging apparatuses as the source of information for generating position and posture information, the continuity of the information is guaranteed by determining the transformation parameters in such a manner that the position and posture information in the pre-switching world coordinate system coincides with that in the post-switching world coordinate system. Meanwhile, the position and posture of the imaging apparatus represented by the transformation parameters obtained as described above are corrected to normal values during the post-switching period so as to maintain the accuracy of the position and posture information regarding the target. This eliminates problems with information continuity and accuracy stemming from the introduction of multiple imaging apparatuses.

Furthermore, the difference in process time between the information processing apparatus in which the local information is aggregated on one hand, and any other information processing apparatus on the other hand, is measured periodically in order to transform timestamps reciprocally therebetween. This provides a common time axis for processes involving communication between the information processing apparatuses, such as a process of integrating the transmitted output values of the IMU sensors and the result of analysis of captured images, or a process of generating the global information and the output data using the transmitted local information. Consequently, the movable ranges of the user and of the target are easily extended without adversely affecting or limiting processing accuracy or output results. Because the degree of freedom is high with respect to the arrangement and the number of imaging apparatuses, an environment optimized for the content of the intended information processing is easily implemented at low cost.

The present invention has been described above in conjunction with a specific embodiment. It is to be understood by those skilled in the art that suitable combinations of the constituent elements and of various processes of the embodiment described above as examples will lead to further variations of the present invention and that such variations also fall within the scope of this invention.

For example, whereas there is one information processing apparatus having the main functions in the above embodiment, two or more information processing apparatuses having the main functions may be configured instead. As another example, there may be provided two or more targets such as HMDs each assigned one information processing apparatus having the main functions. In this case, through processing similar to that of the above embodiment, the position and posture information may be tracked continuously in extensive ranges. As a further example, even where there are multiple targets, only one information processing apparatus having the main functions may be provided to selectively process and output the position and posture information regarding the multiple targets.

### REFERENCE SIGNS LIST

10a Information processing apparatus, 10b Information processing apparatus, 12a Imaging apparatus, 12b Imaging apparatus, 18 HMD, 22 CPU, 24 GPU, 26 Main memory, 130 Captured image acquisition section, 132 Image analysis section, 134 Sensor value acquisition section, 136 Sensor value transmission section, 138 Local information generation section, 140 Local information reception section, 142 Global information generation section, 144 Transformation parameter acquisition section, 146 Imaging apparatus switching section, 148 Coordinate transformation section, 150 Output data generation section, 152 Output section, 160 Captured image acquisition section, 162 Image analysis section, 164 Sensor value reception section, 166 Local information generation section, 168 Local information transmission section

### INDUSTRIAL APPLICABILITY

As described above, the present invention may be applied to diverse information processing apparatuses such as game machines, imaging apparatus, and image display apparatuses, as well as to information processing systems that include any of such apparatuses.

1. An information processing system comprising:
a plurality of imaging apparatuses configured to capture images of a target from different points of view at a predetermined rate; and
an information processing apparatus configured to analyze each of the images covering the target captured by the plurality of imaging apparatuses so as to individually acquire sets of position and posture information regarding the target, the information processing apparatus further using one of the sets of the position and posture information to generate and output final position and posture information at a predetermined rate.

2. The information processing system according to claim 1, further comprising:
a local information generation apparatus configured to be connected with the imaging apparatuses to analyze the image captured by the imaging apparatus of interest so as to acquire the position and posture information regarding the target in a camera coordinate system of the imaging apparatus of interest, wherein
the information processing apparatus includes a local information generation section configured to analyze the image captured by the imaging apparatus connected with an own apparatus in order to acquire the position and posture information regarding the target in the camera coordinate system of the connected imaging apparatus, and
a position and posture information generation section configured to transform in coordinates either the position and posture information acquired by the local information generation section or one of the sets of the position and posture information acquired from the local information generation apparatus so as to generate position and posture information in a world coordinate system common to the imaging apparatuses.

3. The information processing system according to claim 2, wherein
the information processing apparatus includes an imaging apparatus switching section configured such that when the target is in a region where the fields of view of the plurality of imaging apparatuses overlap with each other and when the target meets a predetermined condition, the imaging apparatus switching section switches the imaging apparatus as a source from which to acquire the position and posture information to be transformed in coordinates.

4. The information processing system according to claim 2, wherein the information processing apparatus includes a transformation parameter acquisition section configured such that when the target is in a region where the fields of view of the plurality of imaging apparatuses overlap with each other, the transformation parameter acquisition section acquires relative relations between the positions and postures of the imaging apparatuses on a basis of the position and posture information regarding the target in each of the camera coordinate systems of the imaging apparatuses, the position and posture information being obtained by analyzing the images captured by the imaging apparatuses, the transformation parameter acquisition section further acquiring for each imaging apparatus transformation parameters used for the coordinate transformation.

5. The information processing system according to claim 4, wherein
when the position and posture information regarding the target in each of the camera coordinate systems is transformed in coordinates into information in a world coordinate system, the transformation parameter acquisition section obtains the transformation parameters in such a manner that the position and posture information subsequent to the coordinate transformation is the same as the position and posture information prior to the coordinate transformation.

6. The information processing system according to claim 4, wherein in a period other than a timing at which the imaging apparatus as a source from which to obtain the position and posture information is switched, the transformation parameter acquisition section corrects in steps the transformation parameters using separately acquired information regarding the position and posture of the imaging apparatus.

7. The information processing system according to claim 1, wherein the plurality of imaging apparatuses are disposed in a predetermined arrangement on a plane provided in real space.

8. The information processing system according to claim 7, wherein
the plurality of imaging apparatuses are disposed on a plurality of planes provided in parallel with each other in the real space, the imaging apparatuses being arranged in such a manner that imaging planes thereof face one another.

9. The information processing system according to claim 7, wherein
the plurality of imaging apparatuses are disposed on a plurality of planes encircling a movable range of the target.

10. The information processing system according to claim 2, wherein the local information generation apparatus acquires parameters for transforming a timestamp by measuring relations between a process time of the own apparatus and the process time of the information processing apparatus on a basis of a round-trip propagation time for signals, the local information generation apparatus further generating the timestamp in the process time of the information processing apparatus using the transformation parameters and attaching the generated timestamp to the position and posture information regarding the target in the camera coordinate system when the position and posture information regarding the target in the camera coordinate system is transmitted to the information processing apparatus.

11. The information processing system according to claim 2, wherein the information processing apparatus includes a sensor value acquisition section configured to acquire output values of IMU sensors disposed in the target, and a sensor value transmission section configured to transmit the output values to the local information generation section, and
the local information generation section and the local information generation apparatus integrate the position and posture information obtained by analyzing the images and the output values of the IMU sensors so as to acquire the position and posture information regarding the target in the camera coordinate system.

12. (canceled)

13. A target information acquisition method comprising:
causing a plurality of imaging apparatuses to capture images of a target from different points of view at a predetermined rate; and
causing an information processing apparatus to analyze each of the images covering the target captured by the plurality of imaging apparatuses so as to individually acquire sets of position and posture information regarding the target, the information processing apparatus being further caused to use one of the sets of the position and posture information to generate and output final position and posture information at a predetermined rate.

14. A computer program for a computer, comprising:
by an information processing apparatus, analyzing each of images covering a target captured by a plurality of imaging apparatuses from different points of view at a predetermined rate so as to individually acquire sets of position and posture information regarding the target; and
using one of the sets of the position and posture information to generate and output final position and posture information at a predetermined rate.
